(19) United States
(12) Patent Application Publication
(10) Pub. No.: US 2012/0278297 A1
(43) Pub. Date: Nov. 1, 2012

(54) SEMI-SUPERVISED TRUTH DISCOVERY

(75) Inventors: Xiaoxin Yin, Bothell, WA (US); Wenzhao Tan, Redmond, WA (US)

(73) Assignee: Microsoft Corporation, Redmond, WA (US)

(21) Appl. No.: 13/097,069

(22) Filed: Apr. 29, 2011

(51) Int. Cl. G06F 7/00; G06F 17/30

(52) U.S. Cl. 707/706; 707/748; 707/749; 707/E17.108

(57) ABSTRACT

The described implementations relate to analysis of electronic data. One implementation provides a technique that can include accessing labeled and unlabeled assertions. The technique can also include identifying relationships between individual assertions. The technique can also include determining a confidence score for a first unlabeled assertion based on the relationships.

### BACKGROUND

Electronic data sources can vary greatly in the accuracy of the information that they provide. For example, websites can provide data ranging from very reliable (e.g., government websites such as census data) to very unreliable (e.g., misleading online classifieds). Techniques exist to automatically estimate the reliability of data provided by various websites or other data sources. However, such techniques often produce unsatisfactory results.

For example, one existing technique for evaluating the reliability of data relies on the assumption that data provided by more sources is more accurate than data provided by fewer sources. However, this approach tends to overestimate the truthfulness of data that is copied or otherwise propagated from one data source to another. Moreover, this problem is compounded because, once false data is copied to another data source, the false data is even more likely to be copied by another data source.

### SUMMARY

This document relates to analysis of electronic data. One implementation is manifested as a technique that can include accessing a plurality of assertions that include labeled assertions and unlabeled assertions. The technique can also include identifying one or more relationships between individual assertions from the plurality of assertions. The technique can also include determining a confidence score for a first unlabeled assertion based on the one or more relationships.

Another implementation is manifested as a computer-readable storage media that can include instructions which, when executed by one or more processing devices, can cause the one or more processing devices to perform accessing a plurality of assertions. The plurality of assertions can include labeled assertions and unlabeled assertions. The processing devices can also perform identifying one or more relationships between individual assertions from the plurality of assertions and setting weights for the one or more relationships. The processing devices can also perform iteratively updating confidence scores for the plurality of assertions based on the weights, and, in an instance when the confidence scores converge, outputting the confidence scores.

Another implementation is manifested as a system that can include one or more data structures storing a plurality of assertions comprising labeled true assertions and unlabeled assertions. The plurality of assertions can be provided by a plurality of data sources. The system can also include an assertion analyzer that includes at least one similarity function, a plurality of trustworthiness scores for the data sources, a plurality of relationship weights between the assertions, and a modeling engine. The at least one similarity function can be configured to determine similarity values between individual assertions on a common subject. The relationship weights can reflect the similarity values and the trustworthiness scores. The modeling engine can be configured to iteratively determine confidence scores for the unlabeled assertions based on the relationship weights.

The above listed examples are intended to provide a quick reference to aid the reader and are not intended to define the scope of the concepts described herein.

### BRIEF DESCRIPTION OF THE DRAWINGS

The accompanying drawings illustrate implementations of the concepts conveyed in the present document. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the figure and associated discussion where the reference number is first introduced.

FIG. 1 shows an example of an operating environment in accordance with some implementations of the present concepts.

FIG. 2 shows exemplary components of a device in accordance with some implementations of the present concepts.

FIG. 3 shows a flowchart of an exemplary method that can be accomplished in accordance with some implementations of the present concepts.

FIG. 4 shows an exemplary graphical user interface that can be presented in accordance with some implementations of the present concepts.

FIG. 5 shows exemplary assertions that can be analyzed in accordance with some implementations of the present concepts.

FIGS. 6, 7A, and 7B show exemplary graphs that can be generated in accordance with some implementations of the present concepts.

### DETAILED DESCRIPTION

### Overview

This document relates to analysis of electronic data, and more specifically to using semi-supervised truth discovery techniques to evaluate the truthfulness of assertions included in electronic data. Generally speaking, electronic data taken from one or more data sources can include one or more “assertions.” Some of these assertions, referred to herein as “unlabeled assertions,” can be evaluated to determine a relative confidence that they are true. Other assertions may be known to be true (or false), such as assertions taken from reliable data sources and/or labeled as true or false. These assertions are referred to herein as “labeled assertions.”

The disclosed implementations can infer confidence scores reflecting the trustworthiness of unlabeled assertions based on relationships between the labeled assertions and the unlabeled assertions. The disclosed implementations can also infer the confidence values based on trustworthiness scores for the data sources that provide the unlabeled assertions. Moreover, in some implementations, the trustworthiness scores can also be inferred and/or updated using the confidence values.

One example of a relationship between assertions is that some assertions are mutually supportive. For example, the statement “Company ABC has 21000 employees” and “Company ABC has 21500 employees” are generally mutual supportive. If either statement is correct, the other is likely to be correct as well, although possibly coming from a different survey, at a different time, etc. The disclosed implementations may calculate similar confidence scores for mutually supportive assertions.

Another example of a relationship between assertions is that some assertions are mutually conflicting. For example, the statement “Company ABC was founded in New Mexico” and “Company ABC was founded in Washington” are mutually conflicting. In some implementations, if one of these assertions has a positive confidence score, the other is likely to have a negative confidence score.

Another type of relationship between assertions is that some assertions are provided by the same data source. If a particular data source provides many true assertions and few false assertions, then the data source is relatively trustworthy. Thus, if another assertion is also provided by the data source, this assertion is likely to be true as well. The disclosed implementations may provide for consistency among the confidence scores of assertions that are provided by the same data source. Moreover, the disclosed implementations can infer trustworthiness scores for the data sources that reflect the likelihood that individual assertions from the data sources are true.

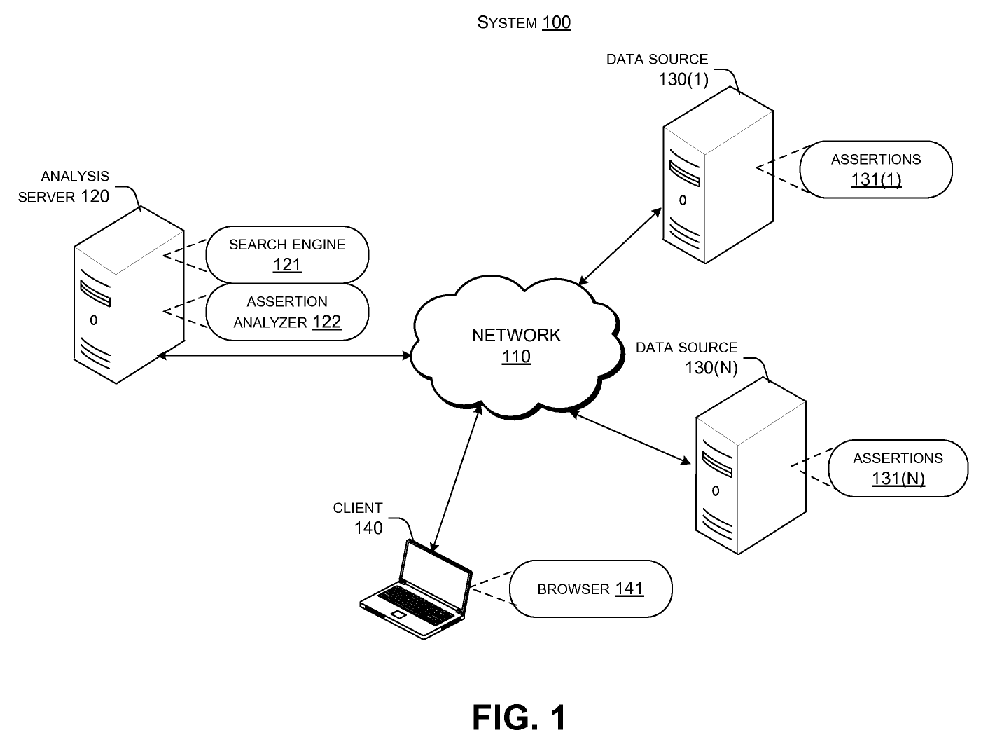

For purposes of explanation, consider introductory FIG. 1. FIG. 1 shows an exemplary system 100 that is consistent with the disclosed implementations. As shown in FIG. 1, system 100 includes a network 110 connecting numerous devices, such as an analysis server 120, data sources 130(1) through 130(N), and one or more client devices 140. By convention, data sources 130(1) through 130(N) will be referred to herein collectively by reference 130 and use the parenthetical to distinguish individual data sources. As discussed in more detail below, each device 120, 130, and/or 140 shown in FIG. 1 can include one or more processing devices, such as computer processors, executing instructions stored on one or more computer-readable storage media devices such as a volatile or non-volatile memory, optical disk, hard drive, flash drive, etc.

Analysis server 120 can host a search engine 121, e.g., a computing program or software module that processes queries received from client device 140. Generally speaking, search engine 121 can respond to the queries with one or more matching web pages or other electronic data items that are hosted by data sources 130. The matching web pages can be displayed by client device 140 using browser 141. Data sources 130 can be any type of devices that provide data that includes assertions, such as web servers, email servers, blog servers, etc. For the purposes of the examples provided herein, data sources 130 are discussed in context of web servers that serve web pages.

The web pages can include various assertions 131(1 . . . N) which, in turn, can have relative degrees of truthfulness. Analysis server 120 can also host an assertion analyzer 122 which can be configured to analyze assertions 131(1 . . . N) to determine confidence scores of individual assertions. In some implementations, search engine 121 can respond to queries with search results that are ranked based on the confidence of the assertions included in the search results. In implementations where data sources 130 provide emails, blogs, etc., assertion analyzer 122 can be configured to determine confidence scores of individual emails or blog entries and/or statements made therein.

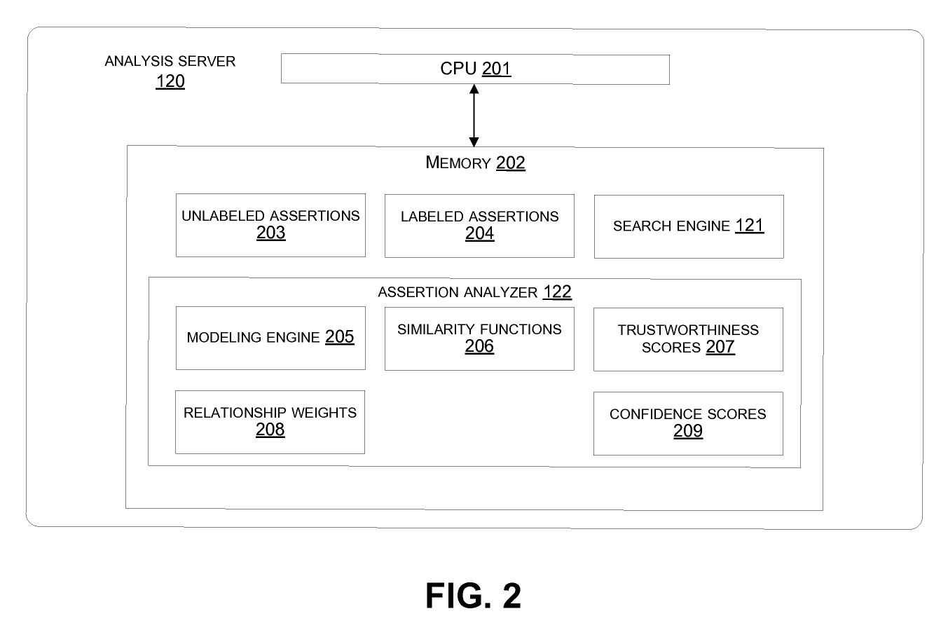

FIG. 2 shows an exemplary architecture of analysis server 120 that is configured to accomplish the concepts described above and below. Analysis server 120 can include a central processing unit (“CPU”) 201 that is operably connected to a memory 202. For example, CPU 201 can be a reduced instruction set computing (RISC) or complex instruction set computing (CISC) microprocessor that is connected to memory 202 via a bus. Memory 202 can be a volatile storage device such as a random access memory (RAM), or a non-volatile memory such as FLASH memory. Although not shown in FIG. 2, analysis server 120 can also include various input/output devices, e.g., a keyboard, a mouse, a display, a printer, etc. Furthermore, analysis server 120 can include one or more non-volatile storage devices, such as a hard disc drive (HDD), optical (compact disc/digital video disc) drive, tape drive, etc. Generally speaking, any data processed by analysis server 120 can be stored in memory 202, and can also be committed to non-volatile storage.

Memory 202 of analysis server 120 can include various components that implement certain processing described herein. For example, memory 202 can include unlabeled assertions 203 and labeled assertions 204. Generally speaking, both unlabeled assertions 203 and labeled assertions 204 can be obtained from data sources 130 via network 110, and can represent a subset of assertions 131. The disclosed implementations can infer confidence values for unlabeled assertions 203 as discussed in more detail below. Generally speaking, the confidence value for a particular assertion can reflect the relative likelihood that the assertion is true.

Labeled assertions 204 can include assertions that are labeled as either being known to be true or false. For example, labeled assertions 204 can include assertions that are taken from an individual data source that is known to be highly trustworthy. In some implementations, labeled assertions 204 include assertions taken from a government web site, online encyclopedia, etc. In other implementations, labeled assertions 204 can include assertions that are validated by an entity such as a human and/or an automated validation process. Memory 202 can also include search engine 121.

Memory 202 can also include assertion analyzer 122, which can include subcomponents such as a modeling engine 205. Modeling engine 205 can be configured to output confidence scores for unlabeled assertions 203. In determining the confidence scores, modeling engine 205 can determine various relationships between individual assertions and the assertions in the truth data, and represent these relationships using weights. The confidence values for individual assertions can be inferred from the relationship weights. As discussed in more detail below, the confidence values can be determined as part of an iterative modeling process that calculates various interim values.

For example, modeling engine 205 can apply one or more similarity functions 206 to determine similarity values between individual labeled assertions and other labeled or unlabeled assertions. Modeling engine 205 can also determine one or more trustworthiness scores 207 which generally represent the trustworthiness of individual data sources 130. Modeling engine 205 can also determine relationship weights 208 between individual assertions. Based on relationship weights 208, modeling engine 205 can calculate and output confidence values 209 for unlabeled assertions 203.

Generally speaking, components 203, 204, and 207-209 can represent data, e.g., one or more data tables or other data structures. Components 121, 122, 205, and 206 can include instructions stored in memory 202 that can be read and executed by central processing unit (CPU) 201. Components 121, 122, and 203-209 can also be stored in non-volatile storage and retrieved to memory 202 to implement the processing described herein. As used herein, the term “computer-readable media” can include transitory and non-transitory instructions. In contrast, the term “computer-readable storage media” excludes transitory instances, and includes volatile or non-volatile storage devices such as those discussed above with respect to memory 202 and/or other suitable storage technologies, e.g., optical disk, hard drive, flash drive, etc.

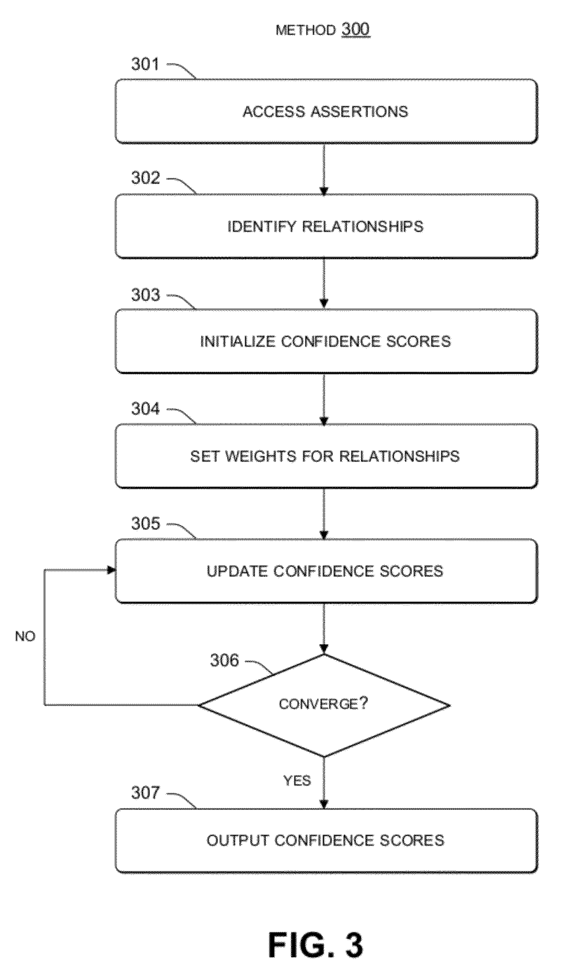

FIG. 3 illustrates a method 300 that is suitable for implementation in system 100 or other systems. Analysis server 120 can implement method 300, as discussed below. Note that method 300 is discussed herein as being implemented on analysis server 120 for exemplary purposes, but is suitable for implementation on many different types of devices.

Assertions can be accessed at block 301. For example, modeling engine 205 can download one or more web pages from data sources 130 and extract individual unlabeled assertions 203 from the web pages. For example, content provider 130(1) can provide a first unlabeled assertion that “John Doe was born on May 1, 1950” and content provider 130(2) can provide a second unlabeled assertion that “John Doe was born on Jun. 12, 1953.” Modeling engine 205 can also download one or more labeled assertions 204 from data sources 130, e.g., a labeled assertion that “John Doe was born on 5/1/1950” that is labeled as being “true.”

Relationships can be identified at block 302. For example, modeling engine 205 can identify assertions from unlabeled assertions 203 and/or labeled assertions 204 that are on the same subject. Generally speaking, assertions can be considered on the same subject when they relate to both a common entity, e.g., John Doe, and a common attribute of the entity, e.g., birth date. Assertions on the same subject can be mutually supportive or can mutually conflict. Modeling engine 205 can also identify relationships between assertions that are from the same data source. In the specific implementations discussed below, the relationships between (1) assertions on the same subject and (2) assertions from the same data source can be modeled as edges of a graph. However, in some implementations, other techniques can be used for representing the relationships. For the purposes of the current example, the three assertions mentioned above are on the common subject of John Doe's birthday and can be from the same data source or different data sources.

Confidence scores can be initialized at block 303. For example, modeling engine 205 can initialize confidence scores 209 for each of the unlabeled assertions 203 to value of 0. Modeling engine 205 can also initialize confidence scores for each of the labeled assertions 204 to a value of 1. As mentioned above, in some implementations, labeled assertions 204 also include known false values, which can be initialized to −1.

Next, weights can be set for the relationships at block 304. For example, modeling engine 205 can set the weight for relationships between assertions on the same subject using similarity functions 206. As an example, a similarity function may indicate that the first unlabeled assertion and the labeled assertion mentioned above are identical (100% mutually supportive), i.e., that “John Doe was born on May 1, 1950” is equivalent to “John Doe was born on 5/1/1950.” The value of the similarity function may be 1 for identical values, so modeling engine 205 can set the weight for the relationship between the first assertion and the labeled assertion to 1.

Likewise, the similarity function may indicate that the second unlabeled assertion and the labeled assertion mentioned above are 100% mutually conflicting, e.g., if it the labeled assertion that “John Doe was born on 5/1/1950” is true then the second unlabeled assertion “John Doe was born on Jun. 12, 1953” is not true. Accordingly, the similarity function may have a value of −1 for these two assertions, which is assigned to the relationship between the second assertion and the labeled assertion. As discussed in more detail below with a different example, block 304 can also include setting weights for relationships between assertions that are on different subjects but are from the same data source.

The confidence scores can be updated at block 305. For example, modeling engine 205 can update the confidence scores for unlabeled assertions 203 and/or labeled assertions 204 based on the weights for the relationships discussed above. The update can be performed to iteratively adjust the confidence scores towards minimizing a loss function over the relationship weights. Exemplary loss functions are discussed in more detail below. In some implementations, the confidence scores for the labeled assertions are set back to their initial values, e.g., 1 for labeled true assertions and -1 for labeled false assertions. This can be performed after the adjusting and before subsequent iterations of block 305.

A determination can be made whether the confidence scores have converged at decision block 306. For example, modeling engine 205 can determine whether the confidence scores have minimized the loss function. In some implementations, modeling engine deems the confidence scores to have converged when the confidence scores and/or loss function do not change by more than a predetermined threshold during a certain number of iterations of block 305. If modeling engine 205 determines that method 300 has not converged, method 300 can return to block 305 and perform another intermediate update to the confidence scores. Otherwise, method 300 can continue to block 307.

At block 307, method 300 outputs the confidence scores. For example, modeling engine 205 can output data that is indicative of the confidence scores for individual unlabeled assertions via network 110, a graphical user interface, etc. In the example introduced above, the confidence score for the first assertion can converge to 1, and the confidence score for the second assertion can converge to −1. In some implementations, the confidence scores are output to search engine 121, which ranks search results for queries based on the confidence values for assertions that are responsive to the queries.

In some implementations, trustworthiness scores 207 can also be determined using method 300. For example, trustworthiness scores for individual data sources 130 can be initialized to a value of 0 at block 303, which generally indicates a neutral level of trustworthiness. Trustworthiness scores 207 can be updated at block 305 with confidence scores 209, and output at block 307. In some implementations, the trustworthiness for a given data source corresponds to the average confidence value of assertions that are provided by that data source.

Note that unlabeled assertions 203 and labeled assertions 204 do not necessarily need to be downloaded from a particular data source. In some implementations, the processing described herein can be performed entirely locally by analysis server 120. For example, unlabeled assertions 203 and labeled assertions 204 can be provided to analysis server 120 via a local storage device or locally-connected processing device instead of over network 110. Furthermore, the various techniques described herein can be distributed across multiple analysis servers and/or other devices. As but one example, a MapReduce™ implementation is mentioned below.

Furthermore, as mentioned above, labeled assertions 204 can be labeled in different ways. In some implementations, one or more of data sources 130 is regarded as a trusted data source, and any assertion downloaded from such a trusted data source is automatically stored as a labeled assertion 204. In other implementations, when assertions 131 are downloaded by assertion analyzer 122, a subset of assertions 131 are provided to a user or an automated verification entity for labeling purposes and then stored on analysis server 120 as labeled assertions 204. In still further implementations, assertions 131 obtained from a given data source can include both labeled and unlabeled assertions. For example, data source 130(1) can be an online encyclopedia with both verified entries and unverified entries. Assertions from the verified entries can be downloaded by analysis server 120 and stored as labeled assertions 204, and assertions from the unverified entries can be stored as unlabeled assertions 203. In still further implementations, unverified entries with assertions that converge to a confidence value above a threshold can be relabeled by the online encyclopedia as verified entries.

Note also that assertion analyzer 122 can be provided locally on client device 140. In such implementations, a user of client device 140 could download a number of web pages from data sources 130 and execute assertion analyzer 122 on client device 140 to determine confidence values for individual assertions in the web pages. This could occur, for example, responsive to client device 140 receiving search results from search engine 121. More generally, method 300 can be performed for assertions included in query results before or after the query results are provided to client device 140.

As another example, one or more data sources 130 can “self-analyze” assertions 131 that are hosted thereon using a locally implemented assertion analyzer 122. In such implementations, data sources 130 provide the confidence scores with the assertions directly to client device 140. In some implementations, data sources 130 can also rank the assertions and provide them in ranked order to client device 140. Furthermore, data sources 130 can implement techniques to provide only certain assertions based on the confidence values. For example, data sources 130 can provide only a threshold number of top-ranked assertions to search engine 121 (and/or client device 140) for a given subject, e.g., the top 10 assertions. As another example, data sources 130 can provide only assertions having higher than a threshold confidence value, e.g., all assertions with a confidence value greater than 0.5. Using such techniques, an individual data source can avoid copying and sharing relatively low-confidence assertions and generally improve the accuracy of the assertions that it provides.

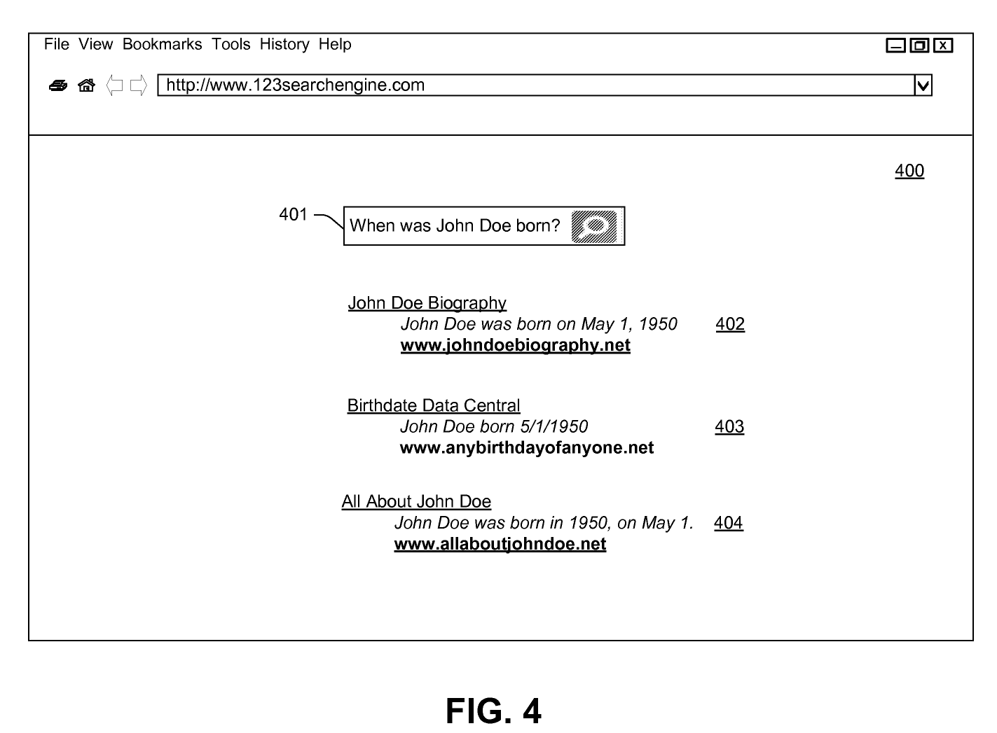

In some implementations, these techniques can instead be performed by search engine 121, e.g., providing only a certain number of top-ranked assertions or assertions with confidence scores above a threshold value to client device 140 in response to queries. FIG. 4 illustrates an exemplary search interface 400 that can be generated by search engine 121 and sent to client device 140 for display by browser 141. Search interface includes a search entry field 401 where a user at client device 140 can enter a search query. In this example, the query is “When was John Doe born?”

In response to the user entering the query, search engine 121 can access one or more web pages that include assertions on the topic of John Doe's birthday. In some implementations, the assertions can be preprocessed by assertion analyzer 122 to determine confidence scores for the individual assertions before the query is received. Alternatively, assertion analyzer 122 can determine confidence scores for the individual assertions responsive to analysis server 120 receiving the query from the user.

In either case, as mentioned above, search engine 121 can respond to the query with search results that include relatively higher-confidence assertions. For example, search engine 121 can respond with three assertions 402, 403, and 404 as shown in FIG. 4. Note that in some implementations assertions 402, 403, and 404 can include different phrasings of the same idea. Furthermore, using the techniques described above, search engine 121 can limit query results to web pages that include relatively high-confidence assertions.

### Graph Models

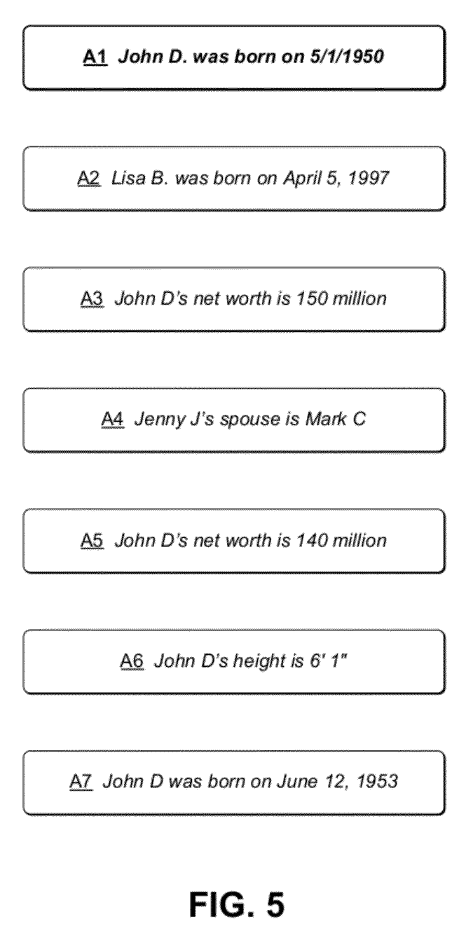

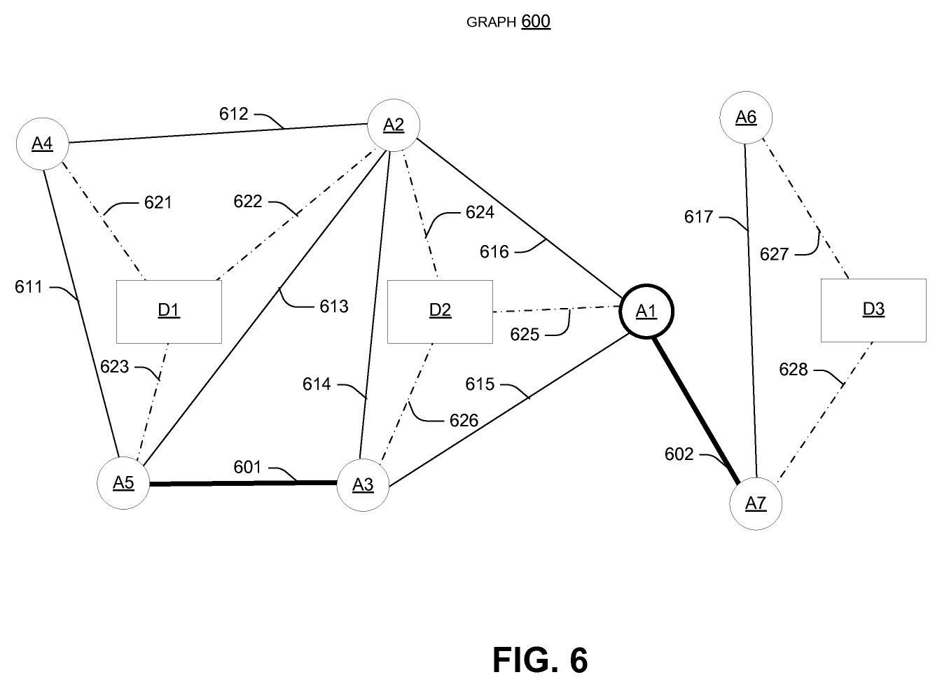

As mentioned above, in some implementations, modeling engine 205 can model the assertions by generating a graph. FIG. 5 illustrates seven assertions A1 through A7. Assertions A1 through A7 will be discussed with respect to FIG. 6, which illustrates an exemplary graph 600. Graph 600 includes seven nodes that represent assertions A1-A7. For the purposes of this example, A1 can represent a labeled assertion that is known to be true, and nodes A2-A7 can represent unlabeled assertions. Graph 600 also includes nodes D1, D2, and D3 which can represent three data sources.

As mentioned above, block 302 of method 300 can include identifying relationships between assertions that (1) are on the same subject or (2) are provided by the same data source. Relationships between assertions on the same subject are represented as edges between these assertions. Thus, e.g., edge 601 indicates that assertions A3 and AS are on the same subject, i.e., John Doe's net worth. Likewise, edge 602 indicates that assertions A1 and A7 are on the same subject, i.e., John Doe's birthday. Note that edges 601 and 602 are shown as thicker solid lines in FIG. 6.

Relationships between assertions from the same data source can also be represented as edges in graph 600. Edges shown as thinner solid lines in FIG. 6 represent relationships between assertions from the same data source. For example, edge 611 indicates that assertions A4 and A5 are from the same data source. Likewise, edge 612 indicates that assertions A4 and A2 are from the same data source, and so on for edges 613, 614, 615, 616, and 617. Dashed lines 621, 622, and 623 respectively indicate that assertions A4, A2, and A5 are provided by data source D1, dashed lines 624, 625, and 626 respectively indicate that assertions A2, A1, and A3 are provided by data source D2, and dashed lines 627 and 628 respectively indicate that assertions A6 and A7 are provided by data source D3. Note that dashed lines 621, 622, and 623 are not necessarily considered edges of graph 600.

As mentioned above, assertion A1 is a labeled assertion that is considered to be true, distinguished by a thicker circle in FIG. 6. Considering FIG. 5, note that assertion A7 is a mutually conflicting assertion with A7, because John D cannot have been born both on May 1, 1950 and Jun. 12, 1953. Thus, a similarity function 206 applied to assertions A1 and A7 may be determined by modeling engine 205 to be close to −1. Accordingly, A7 may have a relatively low confidence score when output by method 300. As discussed in more detail below, when method 300 converges at block 306, assertion A6 is likely to have a low confidence score as well, because assertion A6 is also provided by data source D3. Note also that method 300 can also output a relatively low trustworthiness score for data source D3. Conversely, assertions A2 and A3 may have relatively high confidence scores because they are provided by the same data source as labeled true assertion A1, i.e., data source D2.

Furthermore, note that assertion A5 is generally consistent with, i.e., mutually supportive of, A3. In other words, if assertion A3 that John D's net worth is 150 million is relatively accurate, then assertion A5 that John D's net worth is 140 million is also likely relatively accurate. Accordingly, because A3 is from data source D2 and D2 provided at least one true assertion A1, D2 can be considered relatively trustworthy. Moreover, because A3 is mutually supportive of A5, A5 will likely converge to a relatively high confidence score. Furthermore, the relatively high confidence scores for A2 and A5 will also likely result in a high confidence score for A4 because, like A2 and A5, A4 is provided by data source Dl. Moreover, data source D1 will also likely converge to a relatively high trustworthiness score.

### A Specific Graphing Algorithm

As mentioned above, implementations can use various techniques for modeling the relationships between assertions and determining the confidence values for individual assertions. In one particular implementation introduced above, modeling engine 205 uses a graph representation that includes graph nodes connected by edges. In such implementations, the semi-supervised technique discussed above can be modeled using a graph optimization technique. The optimization technique can assign confidence scores to graph nodes that are consistent with the relationships indicated by the graph edges.

The following discussion provides an analytical solution to this optimization problem that can be computed by modeling engine 205. However, because the analytical solution can be computationally expensive for large data sets, an iterative procedure is also provided that can be computed by modeling engine 205. The iterative procedure can converge toward, and, in some cases, arrive at, an optimal solution.

As mentioned above, a subset of assertions are known in advance to be true and/or false, e.g., labeled assertions 204. In some implementations, relatively few labeled assertions can be used to infer confidence scores for a much larger number of unlabeled assertions. Modeling engine 205 can assign a confidence score to each assertion, so that assertions that are likely to be true have relatively higher scores than assertions that are likely to be untrue.

In some implementations, confidence scores for the individual labeled and unlabeled assertions are represented as real values between −1 and 1. A score close to 1 indicates a high level of confidence that the assertion is true. Conversely, a score close to −1 indicates a high level of confidence that the assertion is false. A score close to 0 indicates relatively little confidence that the assertion is either true or false, e.g., 0 is a “neutral” score. In some implementations, each labeled assertion is considered known to be true, and is assigned a confidence score of 1.

As mentioned above, assertions provided by the same data source can generally tend to have similar confidence scores. Thus, some implementations assign a trustworthiness score to each data source and estimate the confidence scores of individual assertions based partly on the trustworthiness of the data source that provided the assertion. As also mentioned above, mutually supportive assertions can tend to have similar confidence scores. For example, two unlabeled assertions that indicate slightly different population estimates for a given locality, e.g., 35,000 for a first assertion and 35,001 for a second assertion, can tend to have similar confidence scores. If a labeled true assertion indicates the actual population of the locality is 10,000,000, both of these unlabeled assertions will tend to converge toward very negative scores, e.g., −0.99 and −0.98. Conversely, if the labeled true assertion indicates the actual population of the locality is 35,002, the first and second assertion will tend to converge to very positive scores, e.g., 0.98 and 0.99.

As also mentioned above, mutually conflicting assertions tend to have different confidence scores. For example, if one assertion has a high positive score, a mutually conflicting assertion will tend to have a high negative score. This is because, if two assertions are conflicting, they cannot be both true. For example, if a labeled true assertion indicates that John Doe was born in Cleveland and an unlabeled assertion indicates that he was born in Anchorage, the unlabeled assertion is likely wrong and can converge to a low confidence score, e.g., −1.

The following is a formal definition of a semi-supervised truth discovery problem that can be analytically or iteratively solved by modeling engine 205. There are n assertions F={f₁, . . . , fₙ}, each provided by one or more of m data sources D={d₁, . . . , dₘ}. A subset of assertions Fₗ={f₁, . . . , fₗ} are labeled true assertions while the remaining assertions Fᵤ={fₗ₊₁, . . . , fₙ} are unlabeled. Each assertion f is on a subject s(f). For example, the assertion “John Doe was born on 5/1/1950” is about the subject of John Doe's birth date. Two assertions f₁ and f₂ on the same subject may be mutually supportive or mutually conflicting.

A similarity function sim(f₁,f₂) can be provided to indicate the degree of consistency or conflict between any two assertions (−1≦sim(f₁,f₂)≦1). sim(f₁,f₂) can be used in the disclosed implementations to indicate how important it is to assign similar (or different) confidence scores to f₁ and f₂. The definition of sim(f₁, f₂) can be domain-specific and may be provided by an individual with suitable domain knowledge. The similarity function can be symmetric, i.e., sim(f₁, f₂)=sim(f₂,f₁), and sim(f,f)=1 for any assertion f. Each data source can be limited to providing only one assertion for each subject, although an assertion can be a set-value, such as several authors of a book.

As mentioned above, modeling engine 205 can model the relative confidence of assertions as a graph optimization problem. The assertions can be modeled using a graph that includes a node for each assertion and an edge between related pairs of assertions. The information provided by mutually supportive assertions, mutually conflicting assertions, and the trustworthiness of individual data sources can collectively be encoded into the graph using edge weights. wᵢⱼ can represent the weight of the edge between fᵢ and fⱼ, and indicates the relationship of the confidence scores of assertions fᵢ and fⱼ. If fᵢ and fⱼ are provided by the same data source, then wᵢⱼ can set to a positive value α (0<α<1) because if fᵢ has a high (or low) confidence score, fⱼ is likely to have a similar confidence score. Furthermore, if assertions fᵢ and fⱼ are on the same subject, then the weight can be set wᵢⱼ=sim(fᵢ,fⱼ). Otherwise, weight wᵢⱼ can be set to zero.

To model the confidence values of assertions as an optimization problem, modeling engine 205 can apply a loss function. Consider an assignment of confidence scores c=(c₁, . . . ,cₙ), where cᵢ ∈ [−1,1] is the confidence score of assertion fᵢ. In implementations where wᵢⱼ≧0 for i, j, modeling engine 205 can apply the following loss function:

E′(c)=½Σ_{i,j}wᵢⱼ(cᵢ−cⱼ)² Equation 1:

One option is for modeling engine 205 to reduce or minimize E′(c), thus reducing or minimizing the weighted sum of differences between the confidence scores of related assertions. Note that such implementations do not necessarily consider conflicting relationships between facts. This can cause information to be lost. Furthermore, E′(c) can be minimized by assigning the score of 1 to each assertion.

Another option is to use the loss function of Equation 1, but allow wᵢⱼ to be negative. If wᵢⱼ<0 (i.e., assertions fᵢ and fⱼ are in conflict), then E′(c) can be minimized when cᵢ and cⱼ are different from each other. However, under this definition E′(c) is not a convex function and may have many local minimums. This can be computationally difficult for modeling engine 205 to optimize, especially for large-scale problems.

Another option is to use the following loss function, which is a variant of Equation 1 but handles both similarity and dissimilarity between assertions:

$$E ( c ) = \frac{1}{2} {\sum }_{i , j} \vert {w}_{ij} \vert {( {c}_{i} - {s}_{ij} {c}_{j} )}^{2} \\ where {s}_{ij} = \{ \begin{matrix}1 , if {w}_{ij} \geq 0 \\ - 1 , if {w}_{ij} < 0\end{matrix} \qquad Equation 2$$

In order to minimize or reduce E(c), it can be useful for fᵢ and fⱼ to have similar confidence scores when wᵢⱼ>0 (i.e., fᵢ and fⱼ are mutually supportive assertions). When wᵢⱼ<0 (i.e., fᵢ and fⱼ are mutually conflicting assertions), it can be useful for fᵢ and fⱼ to have opposite confidence scores and/or scores both relatively close to zero. As mentioned above, the scores of labeled true assertions can be fixed at 1 and thus, in some implementations, do not change. By minimizing or reducing E(c), modeling engine 205 can produce an assignment of confidence scores that are not only consistent with the relationships among individual assertions, but also consistent with the scores given to the labeled assertions.

### Analytical Solution

The following section provides an analytical solution that can be used by modeling engine 205 to reduce or minimize E(c).

Generally speaking, E(c) is convex in c because each (cᵢ−sᵢⱼcⱼ)² is convex. Therefore, to minimize E(c) modeling engine 205 can find c* such that:

$${\frac{\partial E}{\partial c} \vert}_{c = {c}^{*}} = 0 \qquad Equation 3$$

under the constraint that c₁, . . . , cₗ are fixed to their initial values, e.g., −1 or 1 for labeled assertions. Modeling engine 205 can split c into a labeled set of truth data assertions cₗ=(c₁, . . . , cₗ) and an unlabeled set of assertions cᵤ=(cₗ₊₁, . . . , cₙ). Note that Equation (3) is equivalent to:

∀i ∈{l+1, . . . , n}, Σⱼ|wᵢⱼ|·cᵢ−Σⱼwᵢⱼcⱼ=0 Equation 4:

Equation 4 includes a weight matrix W=[wᵢⱼ], a diagonal matrix D such that Dᵢᵢ=Σⱼ|wᵢⱼ|, and a matrix P=D⁻¹W. The weight matrix W can be split into four blocks as

$$W = [ \begin{matrix}{W}_{ll} & {W}_{lu} \\ {W}_{ul} & {W}_{uu}\end{matrix} ] ,$$

where W_{xy} is an x×y matrix. D and P can be split similarly. Accordingly, Equation 4 can be rewritten as:

(Dᵤᵤ−Wᵤᵤ)cᵤ−Wᵤₗcₗ=0 Equation 5:

Furthermore, if (I−Pᵤᵤ) is invertible:

cᵤ=(Dᵤᵤ−Wᵤᵤ)⁻¹Wᵤₗcₗ=(I−Pᵤᵤ)⁻¹Pᵤₗcₗ Equation 6:

In some implementations, wᵢⱼ>0 for all i,j, can be provided so that (I−Pᵤᵤ) is invertible. This can be impractical for some data sets. Note that a data set with only a hundred thousand facts will have a matrix W with ten billion entries, which can be too big to fit in memory 202. The following implementations are suitable for Web-scale data sets with hundreds of millions of assertions, and provide scalable techniques that can handle sparse matrices and approach or converge to the optimal solution.

Consider an example in which (I−Pᵤᵤ) is not invertible. If, for an unlabeled assertion fₖ (k ∈ (l,n]), wᵢₖ=wₖᵢ=0 for any i≠k, then the k^{th} row and k^{th} column of the matrix (I−Pᵤᵤ) are 0, resulting in a non-invertible (I−Pᵤᵤ). This is not surprising because fₖ is not related to any labeled assertions either directly or indirectly, and its confidence score will remain undefined. In such cases, there may be no unique solution that minimizes E(c). Any confidence score of fₖ yields the same E(c), and therefore fₖ may get an arbitrary confidence score.

Modeling engine 205 can solve this problem by introducing a “neutral assertion” to the set of labeled assertions. A neutral assertion can have a confidence score of 0 and can be connected to any or all unlabeled assertions. Suppose f₁ is the neutral assertion and has a confidence score c₁=0. The weight of the edge between f₁ and an unlabeled assertion fᵢ can be restricted to values that are above zero, i.e., w₁ᵢ=wᵢ₁>0.

Introducing a neutral assertion can have several beneficial consequences. First, the neutral assertion can potentially guarantee the existence of a unique solution that minimizes E(c), as discussed in more detail below. If an unlabeled assertion is not connected to any labeled assertions either directly or indirectly, the unlabeled assertion can have a confidence score of 0 since it is connected to the neutral assertion. Second, the neutral assertion lowers the confidence scores of unlabeled assertions that are only remotely connected to the labeled assertions. This can be desirable because there are sometimes noises in the connections among assertions. Thus, a long sequence of connections introduces more uncertainty, which can lower the confidence score for an assertion. This aspect is discussed in more detail below.

The weight on edges from/to a neutral assertion can be determined in different fashions. One way to set an edge weight for an edge connected to a neutral assertion is to use a constant weight:

w₁ᵢ=wᵢ₁=τ, i=l+1, . . . , n, Equation 7:

where τ>0. Another technique is to assign a weight proportional to the total weight of edges from each node:

w₁ᵢ=wᵢ₁=μ·Σ_{j>1}|wᵢⱼ|, i=l+1, . . . , n, Equation 8:

where μ can be a small constant. Generally speaking, equation 7 is suitable for problems in which the distribution of edges is fairly uniform, i.e., the degrees of the nodes do not differ too much. Equation 8 may be more suitable for problems where different nodes have very different degrees, such as web-scale problems where some nodes have millions of edges while many others have only a few edges.

Modeling engine 205 may generate a graph with edge weights and confidence scores that provide relatively reduced or low values of E(c). Indeed, in some implementations, modeling engine 205 may converge to a unique solution that minimizes E(c). To show that such a unique solution exists, consider the following.

Note that (I−Pᵤᵤ) is positive-definite. Because P=D⁻¹W and Dᵢᵢ=Σⱼ|wᵢⱼ|, it is also true that Σⱼ|Pᵢⱼ|=1 for i=1, . . . , n. Furthermore, because w₁ᵢ>0, it is also true that P₁ᵢ>0 for i=l+1, . . . , n. Moreover, because Pᵤᵤ is a sub-matrix of P, it follows that Σⱼ|[Pᵤᵤ]ᵢⱼ|<1 for i=1, . . . , n−l. Let M=I−Pᵤᵤ. ∀x ∈ [symbol] ^{n-l}/{0},

$${x}^{T} M x = {x}^{T} x - {x}^{T} {P}_{uu} x = {Σ}_{i} {x}_{i}^{2} - {{Σ}_{ij} [ {P}_{uu} ]}_{ij} {x}_{i} {x}_{j} > {Σ}_{ij} \vert {[ {P}_{uu} ]}_{ij} \vert {x}_{i}^{2} - {{Σ}_{ij} [ {P}_{uu} ]}_{ij} {x}_{i} {x}_{j} \geq \frac{1}{2} {Σ}_{ij} \vert {[ {P}_{uu} ]}_{ij} \vert ( {x}_{i}^{2} - 2 {x}_{i} {x}_{j} + {x}_{j}^{2} ) \geq 0$$

Thus, (I−Pᵤᵤ) is positive-definite and is thus invertible. Moreover, as shown above in Equation 5, cᵤ=(I−Pᵤᵤ)⁻¹Pᵤₗcₗ can be a unique solution to minimizing E(c).

### Iterative Computation

As mentioned above, Equation 6 provides an analytical solution to minimizing E(c) that can be used by modeling engine 205 to determine the edge weights and confidence values of a graph. However, under some circumstances, such an analytical solution can be relatively expensive or even impractical to compute. For some scenarios, the number of assertions can be in the tens of thousands, and can even reach hundreds of millions or even greater values. It can be expensive or computationally infeasible to compute the inverse of a matrix of such size or even to materialize the matrix W. The following provides an iterative procedure that can be implemented by modeling engine 205 to compute cᵤ efficiently.

Using the following iterative procedure, modeling engine 205 can compute cᵤ=(I−Pᵤᵤ)⁻¹Pᵤₗcₗ without using matrix inversion or other computationally expensive operations. The confidence score vector c after t iterations is denoted by c^{t}. Modeling engine 205 can initialize the confidence scores by setting cᵢ to 1 or −1 for the labeled assertions for i=1, . . . , l, and setting cᵢ=0 for i=l+1, . . . , n. In this way the initial confidence score vector is c⁰=(c₁, . . . , cₗ, 0, . . . , 0). Modeling engine 205 can repeat the following steps until c converges, e.g., when performing block 305 of method 300.

Step 1: c^{t}=Pc^{t-1}

Step 2: Restore the confidence scores for the labeled assertions, i.e., set c^{t}ᵢ=cᵢ (e.g., 1 or −1) for i=1, . . . , l.

Note that steps 1 and 2 are equivalent to computing:

cᵤ^{t}=Pᵤᵤcᵤ^{t-1}+Pᵤₗcₗ. Equation 9:

The following discussion demonstrates that the technique discussed above converges. First, there is a bound to the sum of each column in Pᵤᵤ

:

∃y<1, such that ∀i=1, . . . , u, Σⱼ|[Pᵤᵤ]ᵢⱼ|≦γ.

As mentioned above, P=D⁻¹W, and thus

$${Σ}_{j} \vert {[ {P}_{uu} ]}_{ij} \vert = \frac{{\sum }_{j = l + 1}^{n} \vert {w}_{ij} \vert}{{\sum }_{j = 1}^{n} \vert {w}_{ij} \vert} \leq 1 - \frac{\vert {w}_{i 1} \vert}{{\sum }_{j = 1}^{n} \vert {w}_{ij} \vert} ,$$

where wᵢ₁ can represent the weight of the edge from fᵢ to the neutral assertion f₁. As set forth above in Equations 7 and 8, wᵢ₁=τ or wᵢ₁=μ·Σ_{j>1}|wᵢⱼ|. If wᵢ₁=τ, let ωₘₐₓ=max_{1≦i≦n}(Σⱼ₌₁ⁿ|wᵢⱼ|) and

$$γ = 1 - \frac{τ}{{ω}_{max}} .$$

If wᵢ₁=μ·Σ_{j>1}|wᵢⱼ|, then

$$1 - \frac{\vert {w}_{i 1} \vert}{{\sum }_{j = 1}^{n} \vert {w}_{ij} \vert} = \frac{1}{1 + μ} ,$$

and let

$$γ = \frac{1}{1 + μ} .$$

In both cases γ<1 and Σⱼ|[Pᵤᵤ]ᵢⱼ|≦γ.

Thus, the convergence of the technique discussed above follows as set forth below:

$${lim}_{t \to ∞} {c}_{u}^{t} = {lim}_{t \to ∞} {P}_{uu}^{t} {c}_{u}^{0} + [ {\sum }_{i = 1}^{t} {P}_{uu}^{i - 1} ] {P}_{ul} {c}_{l} . \qquad Equation 10$$

Consider the sum of each column in matrix Pᵤᵤ^{t}.

Σⱼ[Pᵤᵤ^{t}]ᵢⱼ=Σₖ[Pᵤᵤ^{t-1]}ᵢₖΣⱼ[Pᵤᵤ]ₖⱼ≦Σₖ[Pᵤᵤ^{t-1}]ᵢₖγ≦γt. Equation 11:

Note that, because γ<1,

$${lim}_{t \to ∞} {P}_{uu}^{t} {c}_{u}^{0} = 0 ,$$

the initial point of cᵤ is inconsequential. It follows that cᵤ=(I−Pᵤᵤ)⁻¹Pᵤₗcₗ is a fixed point for function f(x)=Pᵤᵤx+Pᵤₗcₗ, which is the iterative technique mentioned above in Equation 8. This is unique fixed point because the initial point of cᵤ is inconsequential. Thus, modeling engine 205 can use this as a solution to the iterative algorithm.

### Computational Efficiency

The iterative technique presented can converge to the optimal solution, or, alternatively, be stopped before arriving at the optimal solution by determining that the technique has sufficiently converged to move to block 307 of method 300. Furthermore, the technique presented above can avoid the need to compute a matrix inverse. However, in some scenarios there are millions of assertions (e.g., those provided by online encyclopedias, online databases, etc.). Thus, there can be millions times millions of edges in a graph, which makes it computationally infeasible to materialize and store the matrices W and P. The following discussion shows how modeling engine 205 can decompose these matrices so that computation can be done to address these concerns.

As mentioned above, there can be n assertions F={f₁, . . . , fₙ} provided by m data sources D={d₁, . . . , dₘ}, and let d(f) denote the set of data sources that provide an assertion f. Each assertion f can relate to a subject s(f), and two assertions f₁ and f₂ relating to the same subject may be consistent or in conflict with each other as indicated by sim(f₁,f₂). Modeling engine 205 can build a graph as follows.

Assertions on the same subject can be connected to each other, e.g., for any fᵢ and fⱼ that s(fᵢ)=s(fⱼ), wᵢⱼ=(fᵢ, fⱼ). Also, assertions from the same data source can be connected to each other. Thus, if a data source dₖ provides both fᵢ and fⱼ, this will contribute a certain weight to the edge weight between fᵢ and fⱼ. Moreover, for any fᵢ and fⱼ that d(fᵢ) ∩ d(fⱼ)≠, wᵢⱼ=α·|d(fᵢ) ∩ d(fⱼ)|, where α ∈ (0,1).

In each iteration, modeling engine 205 can compute:

c^{t}=Pc^{t-1}=D⁻¹Wc^{t-1}, Equation 12:

and modeling engine 205 can decompose both D and W for efficient computation.

As mentioned before, in some implementations a data source is prevented from providing multiple assertions on the same subject. In other words, the modeling engine can enforce a requirement that if d(f) ∩ d(fⱼ)≠, then s(f)≠s(fⱼ). Thus, matrix W can be decomposed into two sparse matrices without overlapping entries: W=Wₛ+W_{d}, where [Wₛ]ᵢⱼ=sim(fᵢ,fⱼ) if s(fᵢ)=s(fⱼ) and [W_{d}]ᵢⱼ=α·|d(fᵢ) ∩ d(fⱼ)| if d(fᵢ) ∩ d(fⱼ)≠. Modeling engine 205 can also decompose D as D=Dₛ+D_{d}, where [Dₛ]ᵢᵢ=[Wₛ]ᵢⱼ and [D_{d}]ᵢᵢ=Σⱼ|[W_{d}]ᵢⱼ|.

The number of non-zero entries in Wₛ can be relatively small because the number of unique values for each subject can be relatively small. Therefore, Wₛ can be stored as a sparse matrix and Dₛ can be computed from the sparse matrix. In contrast, W_{d} can contain billions or trillions of non-zero entries because some data sources may provide millions of assertions. Thus, modeling engine 205 can further decompose W_{d}. Let V be a n×m matrix and

$${V}_{ik} = \{ \begin{matrix}1 , & if {d}_{k} ∈ d ( {f}_{i} ) ; \\ 0 , & otherwise .\end{matrix}$$

Note that |d(fᵢ) ∩ d(fⱼ)|=Σₖ₌₁^{m}VᵢₖVᵢₖ, and thus W_{d}=αVV^{T}. Therefore,

Wc^{t-1}=Wₛc^{t-1}+αVV^{T}c^{t-1} Equation 13:

which can be computed by modeling engine 205 because Wₛ is of a relatively manageable size, V is part of the input, and VV^{T}c^{t-1} can be computed by two operations of multiplying a vector by a matrix.

The diagonal matrix D can also be computed efficiently by modeling engine 205. Dₛ can be computed from Wₛ, and D_{d} can be computed as:

[D_{d}]ᵢᵢ=αΣⱼΣₖ₌₁^{m}VᵢₖVⱼₖ=αΣₖ₌₁^{m}Vᵢₖ(ΣⱼVⱼₖ) Equation 14:

Let |dₖ| be the number of assertions provided by data source dₖ. Since |dₖ|=Σⱼ Vⱼₖ, it follows that [D_{d}]ᵢᵢ=α Σₖ₋₁^{m}Vᵢₖ|dₖ|. In this way Dₛ and D_{d} can be pre-computed by modeling engine 205, and modeling engine 205 can also compute c^{t}=D⁻¹Wc^{t-1}. In some implementations, the only operation involved in each iteration is multiplying a vector by a sparse matrix. Modeling engine 205 can implement this algorithm in a distributed computing framework such as MapReduce™ and run the algorithm in a distributed framework.

### Decay of Confidences

As mentioned above, in some implementations modeling engine 205 introduces one or more neutral assertions to provide for the existence of a unique solution. Furthermore, using one or more neutral assertions can allow the iterative technique discussed above to converge. In some scenarios, introducing a neutral assertion is similar to introducing a small decay to the confidence scores of assertions in each iteration.

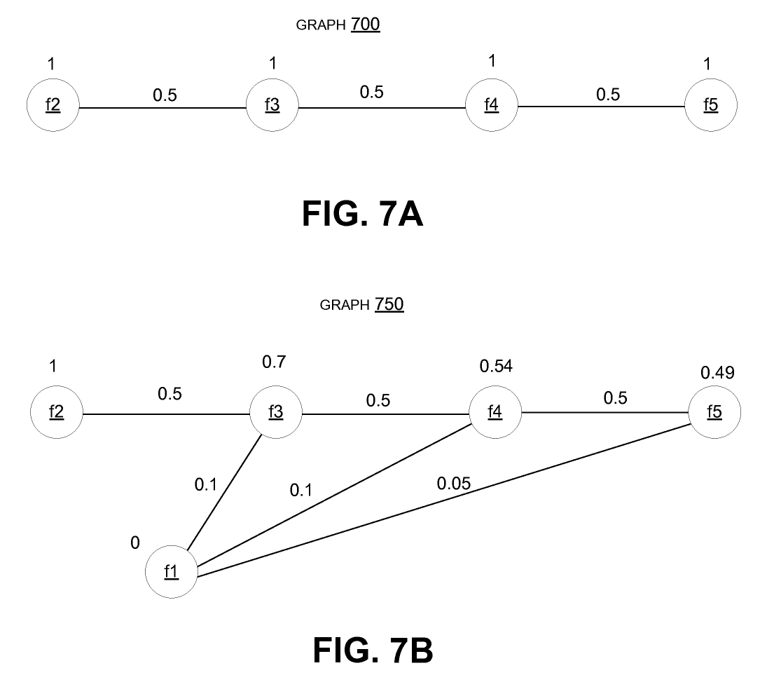

First consider the technique discussed above performed with and without a neutral assertion. FIG. 7A illustrates a graph 700 without a neutral assertion, and FIG. 7B illustrates a graph 750 with a neutral assertion f₁. For the purposes of this example, graphs 700 and 750 each include one labeled true assertion f₂ with confidence score 1, and three unlabeled assertions f₃, f₄, f₅. The weights of edges to and from the neutral assertion are discussed above with respect to Equation 8, with μ=0.1. The weights of edges and confidence scores are shown in FIGS. 7A and 7B.

In order to minimize E(c), in graph 700 the confidence scores of f₃, f₄, and f₅ can be set to 1. Generally speaking, in any graph where the labeled assertions have confidence scores of 1 and there are no negative edges, any unlabeled assertion connected to any labeled assertion can have score of 1. This can be true regardless of how far away the unlabeled assertions are from the labeled assertions. Such assignment of scores is not necessarily reasonable, because modeling engine 205 has different confidences in the correctness of these assertions. For example, f₅ may be provided by the same data source as f₄, which is somewhat similar to f₃, which is provided by the same data source as f₂. Since f₂ is true, modeling engine 205 can be relatively confident that f₃ is also true, somewhat less confident for f₄, and relatively doubtful of f₅. This is because each hop, e.g., additional edge away from a labeled assertion, introduces uncertainty.

Modeling engine 205 can model this uncertainty and the resulting decrease in confidence of individual assertions. To do so, modeling engine 205 can use the concept of propagation decay, which can substitute for using the neutral assertion discussed above and shown in graph 750. The following discussion compares the computation in graphs 700 and 750 using D̅, S̅, W̅, P̅ and c̅ to represent the matrices and vectors.

Consider the computation in graph 700, which does not have a neutral assertion. In each iteration, modeling engine 205 can propagate the confidence scores with the equation c̅^{t}= P̅ c̅^{t-1} from each node to its neighbors using the matrix P̅. Modeling engine 205 can introduce some decay in each iteration, as follows.

In Step 1 of each iteration, when propagating confidence scores from a labeled assertion fᵢ to an unlabeled assertion fⱼ, modeling engine 205 can add the score Σ P̅ᵢⱼ c̅^{t-1}ᵢ to c̅^{t}ⱼ, instead of P̅ᵢⱼ c̅^{t-1}ᵢ, where ρ ∈ (0,1) is a decay factor. This can also be written as c̅^{t}=ρ P̅ c̅^{t-1}.

The following discussion shows how adding a propagation decay can substitute for, or be equivalent to, adding a neutral assertion in a graph.

Let c̅ᵤ^{t} be the confidence score vector of unlabeled assertions in graph 700 without a neutral assertion after t iterations with propagation decay. Let cᵤ^{t} be the confidence score vector in graph 750 with a neutral assertion but without propagation decay, where the weight of edges to/from the neutral fact is set as discussed above with respect to Equation 8. Thus,

$${c}_{u}^{t} = ρ {\overline{c}}_{u}^{t} if ρ = \frac{1}{( 1 + μ )} . \qquad Equation 14$$

Consider the computation in graph 750. In each iteration modeling engine 205 computes c^{t}=Pc^{t-1}, which can be rewritten as

$$[ \begin{matrix}{c}_{l}^{t} \\ {c}_{u}^{t}\end{matrix} ] = [ \begin{matrix}{P}_{ll} & {P}_{lu} \\ {P}_{ul} & {P}_{uu}\end{matrix} ] [ \begin{matrix}{c}_{l}^{t - 1} \\ {c}_{u}^{t - 1}\end{matrix} ] .$$

Because cₗ is restored to its original value after each iteration, the computation in each iteration is actually cᵤ^{t}=Pᵤᵤcᵤ^{t-1}+Pᵤₗcₗ. With induction it can be shown that cᵤ^{t}=Pᵤᵤ^{t}cᵤ⁰+[Σᵢ₌₁^{t}Pᵤᵤⁱ⁻¹]Pᵤₗcₗ. Because of setting cᵤ⁰=0, it follows that:

cᵤ^{t}=[Σᵢ₌₁^{t} Pᵤᵤⁱ⁻¹]Pᵤₗcₗ. Equation 15:

Now consider the influence of the neutral assertion on Pᵤᵤ and Pᵤₗ. Recall that P=D⁻¹W. Since Dᵢᵢ=Σⱼ|wᵢⱼ|, D̅ᵢᵢ=Σ_{j>1}|wᵢⱼ|, and w₁ᵢ=wᵢ₁=μ·Σ_{j>1}|wᵢⱼ|, it follows that Dᵢᵢ=(1+μ) D̅ᵢᵢ and thus Dᵤᵤ=(1+μ) D̅ᵤᵤ. From the definition of Pᵤₗ it also follows that Pᵤₗcₗ=Dᵤᵤ⁻¹Wᵤₗcₗ. Moreover, because Wᵤₗ only differs with W̅ᵤₗ in the first column, and cₗ= c̅ₗ and cₗ_{₁}= c̅ₗ_{₁}=0, it also follows that:

$${W}_{ul} {c}_{l} = {\overline{W}}_{ul} {\overline{c}}_{l} \\ ⇒ {P}_{ul} {c}_{l} = {( ( 1 + μ ) {\overline{D}}_{uu} )}^{- 1} {\overline{W}}_{ul} {\overline{c}}_{l} = \frac{1}{( 1 + μ )} {\overline{P}}_{ul} {\overline{c}}_{l}$$

Furthermore, because Wᵤᵤ= W̅ᵤᵤ, it is also true that

$${P}_{uu} = \frac{1}{( 1 + μ )} {\overline{P}}_{uu} .$$

### Therefore:

$${c}_{u}^{t} = \frac{1}{( 1 + μ )} [ {\sum }_{i = 1}^{t} {( \frac{1}{( 1 + μ )} {\overline{P}}_{uu} )}^{i - 1} ] {\overline{P}}_{ul} {\overline{c}}_{l} \qquad Equation 16$$

In implementations where modeling engine 205 iterates with propagation decay, in each iteration modeling engine 205 can compute c̅ᵤ^{t}=ρ P̅uu c̅ᵤ^{t-1}+ P̅ᵤₗ c̅ₗ. As discussed above with respect to Equation 9, it can be shown that c̅ᵤ^{t}=[Σᵢ₌₁^{t}(ρ P̅ᵤᵤ)ⁱ⁻¹] P̅ᵤₗ c̅ₗ, which is in turn similar to Equation 16. If

$$ρ = \frac{1}{( 1 + μ )} ,$$

then cᵤ^{t}=ρ c̅ᵤ^{t}.

As discussed above, adding a neutral assertion to a graph can achieve the same effect as performing propagation decay in each iteration. Thus, in some implementations when a neutral assertion is used, the modeling engine does not also need to perform propagation decay.

### Conclusion

Using the described implementations, computer data can be analyzed using modeling techniques to determine confidence values for unlabeled assertions. The confidence values can be output to a search engine or other entity for further processing, e.g., used to order query results, etc.

Although techniques, methods, devices, systems, etc., pertaining to the above implementations are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A method comprising:
accessing a plurality of assertions, the plurality of assertions including one or more labeled assertions having labels and one or more unlabeled assertions, wherein the labels of the one or more labeled assertions indicate relative degrees of truthfulness of corresponding labeled assertions;
identifying one or more relationships among the plurality of assertions; and
determining a confidence score of a first unlabeled assertion based on an individual relationship connecting the first unlabeled assertion to an individual labeled assertion, wherein the confidence score is computed using an individual label indicating an individual relative degree of truthfulness of the individual labeled assertion to which the first unlabeled assertion is connected,
wherein at least the determining the confidence score is performed by one or more processing devices.

2. The method of claim 1, wherein the one or more relationships include a first relationship between at least two individual assertions that are on the same subject.

3. The method of claim 2, further comprising:
setting a weight for the first relationship by applying a similarity function to the at least two individual assertions that are on the same subject.

4. The method of claim 1, wherein the one or more relationships include a first relationship between at least two individual assertions that are both provided by a common data source.

5. The method of claim 4, further comprising:
setting a weight for the first relationship based on a trustworthiness score for the common data source, the trustworthiness score reflecting an average confidence score for assertions that are provided by the common data source.

6. The method of claim 1, wherein at least some of the labels indicate that the corresponding labeled assertions are truthful assertions.

7. The method according to claim 1, further comprising:
representing the plurality of assertions as nodes of a graph and the one or more relationships as edges of the graph.

8. The method according to claim 7, further comprising:
including an individual node in the graph that represents a neutral assertion.

9. The method according to claim 8, wherein the neutral assertion has an assigned confidence score of zero.

10. The method according to claim 1, wherein the confidence score is determined iteratively using at least one intermediate update to the confidence score.

11. One or more computer-readable storage media devices comprising instructions which, when executed by one or more processing devices, cause the one or more processing devices to perform:
accessing a plurality of assertions, the plurality of assertions including one or more labeled assertions having labels and one or more unlabeled assertions, wherein the labels of the one or more labeled assertions reflect whether the one or more labeled assertions are truthful assertions;
identifying one or more relationships between individual assertions from the plurality of assertions;
setting weights for the one or more relationships;
iteratively updating confidence scores of the plurality of assertions based on the weights; and
in an instance when the confidence scores converge, outputting the confidence scores,
wherein the confidence scores of the one or more labeled assertions are based on the labels reflecting whether the one or more labeled assertions are truthful assertions.

12. The one or more computer-readable storage media devices according to claim 11, wherein the iteratively updating comprises updating the confidence scores of mutually supportive assertions to become relatively more similar.

13. The one or more computer-readable storage media devices according to claim 11, wherein the iteratively updating comprises updating the confidence scores of mutually conflicting assertions to become relatively less similar.

14. The one or more computer-readable storage media devices according to claim 11, wherein the iteratively updating comprises updating the confidence scores of assertions from a data source to become relatively more similar to a trustworthiness score of the data source.

15. A system comprising:
one or more data structures storing a plurality of assertions comprising labeled true assertions and unlabeled assertions, wherein the plurality of assertions are provided by a plurality of data sources and the labeled true assertions are known to be truthful statements;
an assertion analyzer comprising:
at least one similarity function configured to determine similarity values between individual assertions on a common subject;
a plurality of trustworthiness scores for the plurality of data sources;
a plurality of relationship weights of relationships among the plurality of assertions, the relationship weights reflecting the similarity values and the trustworthiness scores; and
a modeling engine configured to:
initialize multiple first confidence scores of the labeled true assertions to a common value; and
iteratively determine second confidence scores of the unlabeled assertions based on the relationship weights and the multiple first confidence scores; and
one or more processing devices configured to execute the assertion analyzer.

16. The system according to claim 15, further comprising:
a search engine configured to receive a query and provide query results that include a subset of the unlabeled assertions.

17. The system according to claim 16, wherein the subset of the unlabeled assertions comprises individual unlabeled assertions that are responsive to the query and that have second confidence values higher than a threshold value.

18. (canceled)

19. The system according to claim 16, embodied on an analysis server.

20. The system of claim 16, wherein the search engine and the assertion analyzer are embodied on separate computing devices.

21. The system of claim 15, the modeling engine being configured to initialize the multiple first confidence scores of the labeled true assertions to the common value of 1.

22. The method of claim 1, wherein the one or more relationships are pairwise relationships between pairs of assertions.

23. The method of claim 1, wherein the first unlabeled assertion is:
directly connected to the individual labeled assertion, or
indirectly connected to the individual labeled assertion through one or more other assertions.
